(19) United States
(12) Patent Application Publication
(10) Pub. No.: US 2022/0203492 A1
(43) Pub. Date: Jun. 30, 2022

(54) PRESS DEVICE, CONTROL METHOD FOR PRESS DEVICE, AND NON-TRANSITORY COMPUTER READABLE MEDIUM STORING CONTROL PROGRAM

(71) Applicant: SUMITOMO HEAVY INDUSTRIES, LTD., Tokyo (JP)

(72) Inventor: Masashi Tado, Ehime (JP)

(21) Appl. No.: 17/561,241

(22) Filed: Dec. 23, 2021

(30) Foreign Application Priority Data
Dec. 25, 2020 (JP) 2020-217065

(51) Int. Cl. B23Q 15/12; B21D 22/02

(52) U.S. Cl. CPC B23Q 15/12; B21D 22/022

(57) ABSTRACT

There is provided a press device which causes a slide to advance and retreat to forge a forming object by using a die heated to a predetermined temperature. The press device includes a determination unit that determines whether or not a press operation enters a stable forging period during which a mechanical load acting on the slide in a press direction is stable, and a controller that adjusts a force acting on the forming object from the die to deform the forming object, based on a predetermined measurement value, when the determination unit determines that the press operation enters the stable forging period.

### RELATED APPLICATIONS

The content of Japanese Patent Application No. 2020-217065, on the basis of which priority benefits are claimed in an accompanying application data sheet, is in its entirety incorporated herein by reference.

### BACKGROUND

### Technical Field

Certain embodiments of the present invention relate to a press device, a control method for a press device, and a non-transitory computer readable medium storing a control program.

### Description of Related Art

In the related art, for example, in press devices having a plurality of press processes, a press device is known in which a shut height (height from a bottom dead center position of a slide to an upper surface of a bed) is adjusted to accurately form a thickness of a forming product (for example, refer to the related art).

The shut height is adjusted when a load corresponding to a workpiece disposition pattern on a die having a plurality of processes exceeds a predetermined threshold, and is effectively adjusted in the following cases A to C.

A: When the number of workpieces existing inside the press device is gradually changed, such as when forging starts or ends

B: When deviated from a normal workpiece disposition pattern

C: When the shut height is changed due to thermal expansion

### SUMMARY

According to an embodiment of the present invention, there is provided a press device which causes a slide to advance and retreat to forge a forming object by using a die heated to a predetermined temperature.

The press device includes a determination unit that determines whether or not a press operation enters a stable forging period during which a mechanical load acting on the slide in a press direction is stable, and a controller that adjusts a force acting on the forming object from the die to deform the forming object, based on a predetermined measurement value, when the determination unit determines that the press operation enters the stable forging period.

According to another embodiment of the present invention, there is provided a control method for a press device which causes a slide to advance and retreat to forge a forming object by using a die heated to a predetermined temperature.

The control method includes determining whether or not a press operation enters a stable forging period during which a mechanical load acting on the slide in a press direction is stable, and adjusting a force acting on the forming object from the die to deform the forming object, based on a predetermined measurement value, when the determination process determines that the press operation enters the stable forging period.

According to still another embodiment of the present invention, there is provided a non-transitory computer readable medium storing a control program for a press device which causes a slide to advance and retreat to forge a forming object by using a die heated to a predetermined temperature.

The control program causes a computer to execute a process including determining whether or not a press operation enters a stable forging period during which a mechanical load acting on the slide in a press direction is stable, and adjusting a force acting on the forming object from the die to deform the forming object, based on a predetermined measurement value, when the determination unit determines that the press operation enters the stable forging period.

### BRIEF DESCRIPTION OF THE DRAWINGS

FIG. 1 is a view illustrating a press device according to an embodiment.

FIG. 2 is a side view of a main part of a device main body of the press device according to the embodiment, and is a view for describing a shut height adjustment mechanism.

FIG. 3 is a block diagram illustrating a schematic control configuration of the press device according to the embodiment.

FIG. 4 is a flowchart illustrating a flow of a shut height adjustment process.

FIG. 5 is a graph illustrating an example of time-dependent changes in a shut height, a die temperature, a load, and a forming product thickness in the shut height adjustment process.

FIG. 6 is a graph illustrating an example of time-dependent changes in a shut height, a load, and a knockout force after a stable forging period.

### DETAILED DESCRIPTION

Incidentally, for example, a material in which a temperature of a workpiece when forging ends may sensitively affect product quality is forged in a state where a die is heated to a predetermined temperature or higher. In a case of the forging, a film of a die lubricant is less likely to be uniformly formed on a die surface. Particularly, in a case of the die lubricant whose solvent is water, a Leidenfrost phenomenon may occur due to boiling in some cases. As a result, residues of the die lubricant adhere to the die surface due to repeated press operations. When the forging is performed by the die in a state where the residues are unevenly distributed, poor quality such as a poor wall thickness and an insufficient thickness.

According to shut height adjustment in the related art, it is possible to improve the poor wall thickness caused by a workpiece disposition pattern or thermal expansion of the die. However, the shut height adjustment in the related art does not effectively function to improve the poor quality caused by the residues of the die lubricant.

It is desirable to suppress poor quality caused by residues of a die lubricant.

According to an embodiment of the present invention, it is possible to suppress poor quality caused by residues of a die lubricant.

Hereinafter, embodiments according to the present invention will be described in detail with reference to the drawings.

### Configuration of Press Device

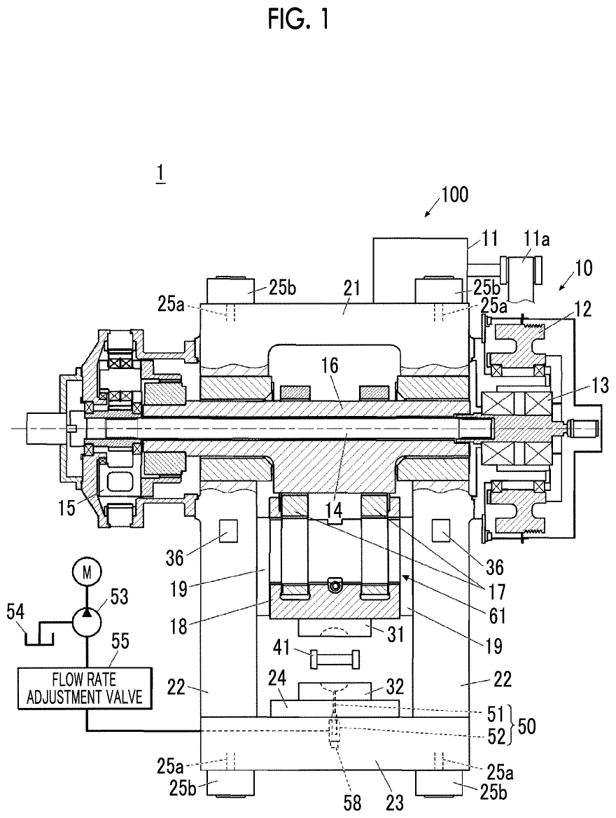

FIG. 1 is a view illustrating a press device 1 according to an embodiment of the present invention.

As illustrated in the drawing, the press device 1 according to the present embodiment is a forging press device that performs hot forging, and includes a device main body 100. The device main body 100 includes a bed 23, a plurality of uprights 22, a crown 21, a bolster 24, a slide 18, a drive unit 10, a plurality of load meters 36, a lubrication device 41, and a knockout device 50.

The bed 23, the plurality of uprights 22, and the crown 21 form a frame unit of the press device 1. A tie rod 25a is inserted into the bed 23, the plurality of uprights 22, and the crown 21, and is tightened by a tie rod nut 25b so that the bed 23, the plurality of uprights 22, and the crown 21 are fastened to each other.

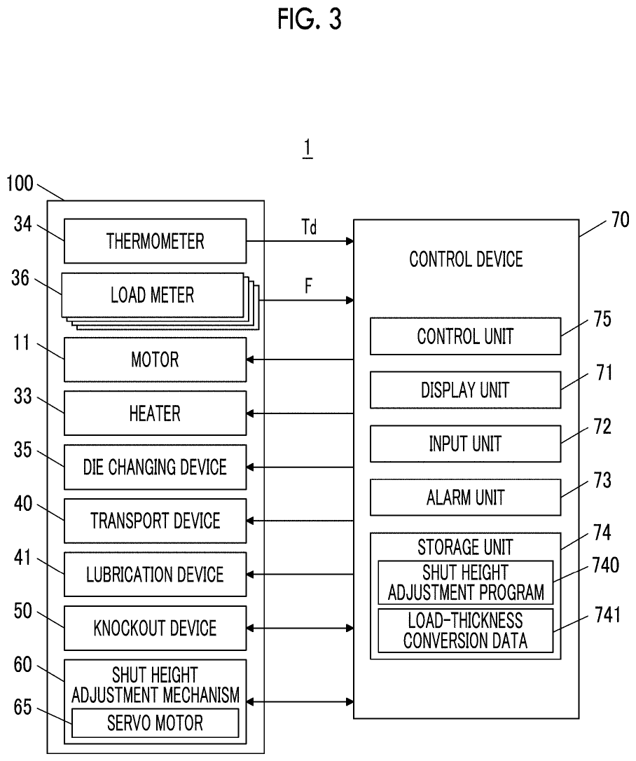

The bolster 24 is fixed onto the bed 23, and a lower die 32 is fixed to an upper portion of the bolster 24. The bolster 24 includes a built-in heater 33 (refer to FIG. 3), and the lower die 32 can be heated by the heater 33. An upper bolster may be provided between the upper die 31 and the slide 18, and a built-in heater capable of heating the upper die 31 may be provided in the upper bolster to control a temperature of the upper die 31.

In addition, the bolster 24 is provided with a thermometer 34 (refer to FIG. 3) for measuring a die temperature Td of the lower die 32. A position or the number of the thermometers 34 is not particularly limited as long as the thermometer 34 can measure the temperature correlated with the temperature of at least one of the upper die 31 and the lower die 32, as the die temperature Td. For example, the thermometer 34 maybe provided in a lower portion of the slide 18.

The slide 18 is supported by a guide 19 provided in each of the uprights 22 to be capable of advancing and retreating in an upward-downward direction. The upper die 31 is fixed to a lower portion of the slide 18. A direction in which the slide 18 advances and retreats is not particularly limited. However, the present embodiment will be described as an example in which the slide 18 advances and retreats in the upward-downward direction.

A plurality of sets of the upper die 31 and the lower die 32 are aligned in a rightward-leftward direction of the paper surface in FIG. 1 (only one set is illustrated in FIG. 1), and face those respectively forming a set in the upward-downward direction. The upper die 31 and the lower die 32 are formed so that a die shape is close to a final shape of the forming product in accordance with an alignment sequence. When the slide 18 descends, the upper die 31 and the lower die 32 are moved close to each other, and a forming object is forged and formed between the upper die 31 and the lower die 32.

In addition, the device main body 100 includes a die changing device 35 (refer to FIG. 3) for changing at least one of the upper die 31 and the lower die 32. For example, as the die changing device 35, the device disclosed in Japanese Patent No. 3540188 can preferably be applied.

The drive unit 10 is a mechanism that causes the slide 18 to advance and retreat, and includes a motor 11, a flywheel 12, a clutch brake 13, a transmission shaft 14, a reduction gear 15, an eccentric shaft 16, and a connecting rod (connecting rod) 17.

The motor 11 is connected to the flywheel 12 via a belt 11a, and the flywheel 12 is rotated by power of the motor 11. The clutch brake 13 switches connection and disconnection between the flywheel 12 and the transmission shaft 14, and brakes the transmission shaft 14. When the flywheel 12 and the transmission shaft 14 are connected by the clutch brake 13, a rotational motion of the flywheel 12 is transmitted to the transmission shaft 14, the reduction gear 15, and the eccentric shaft 16 in this order. Thereafter, the rotational motion is converted into a translational motion of the slide 18 via the connecting rod 17, and the slide 18 advances and retreats in the upward-downward direction.

The drive unit 10 may be provided with any configuration including the eccentric shaft 16 to cause the slide 18 advance and retreat, and a specific configuration thereof is not limited to the above-described example.

The plurality of load meters 36 are respectively provided in the plurality of uprights 22. For example, each of the load meters 36 measures the amount of strain of the mounted upright 22, measures a load acting on the upright 22 in the upward-downward direction, and outputs a measurement result thereof to a control device 70 (to be described later). The control device 70 acquires a load F acting on the slide 18 in a press direction, based on the load measured by each of the load meters 36. The load meter 36 may not be provided in all of the uprights 22. For example, in the press device 1 having a symmetrical shape in the forward-rearward direction, the load meter 36 may be provided in the two uprights 22 on the front side, or may be provided in only the two uprights 22 located at diagonal positions.

The lubrication device 41 sprays a die lubricant onto a die surface. The lubrication device 41 is configured to be capable of advancing and retreating in a direction perpendicular to the press direction. When the upper die 31 and the lower die 32 are separated from each other, the lubrication device 41 enters therebetween, and sprays the lubricant. The die lubricant improves a lubrication state between the die and a workpiece. For example, forming is facilitated by suppressing a possibility that the workpiece may stick to the die.

In addition, a transport device 40 (refer to FIG. 3) for transporting the forming object (workpiece) is provided in the vicinity of the lubrication device 41. When the upper die 31 and the lower die 32 are separated from each other, the transport device 40 supplies a new forming material to the upper die 31 and the lower die 32 which are located on the most upstream side, or transports the forming objects sequentially to the plurality of sets of the upper die 31 and the lower die 32 which are arrayed in a row.

The knockout device 50 is a so-called bed knockout (BKO) device that separates the forming object from the lower die 32 on the bed 23, and includes a knockout pin 51, a hydraulic cylinder 52, a hydraulic pump 53, and a flow rate adjustment valve 55.

The knockout pin 51 is a pin that penetrates the bolster 24 and the lower die 32 and pushes the forming object upward from the inside of the lower die 32.

The hydraulic cylinder 52 includes a piston that advances and retreats in the upward-downward direction, and causes the knockout pin 51 mounted on the piston to advance and retreat in the upward-downward direction. In addition, the hydraulic cylinder 52 is provided with a position sensor 58 that detects a position of the knockout pin 51 in an advancing and retreating direction. The position sensor 58 detects the position of the knockout pin 51 in the upward-downward direction, and outputs the detected position to the control device 70 (to be described later).

The hydraulic pump 53 is connected to a tank 54 that stores the oil and the hydraulic cylinder 52, and supplies the oil stored inside the tank 54 to the hydraulic cylinder 52.

The flow rate adjustment valve 55 is a servo valve that switches a connection state between the hydraulic cylinder 52 and the hydraulic pump 53 and controls an oil supply amount by using pressure oil stored in an accumulator (not illustrated). Specifically, the flow rate adjustment valve 55 switches a state of the hydraulic cylinder 52 to one of an advancing (ascending) state, a retreating (descending) state, and a state of maintaining a current position of the knockout pin 51. In addition, the flow rate adjustment valve 55 can control a flow rate of the pressure oil supplied to the hydraulic cylinder 52 in any desired way by using the accumulator.

The knockout device 50 is not limited to the BKO device, and may be a slide knockout (SKO) device that separates the forming object downward from the upper die 31, or may include both of these. In addition, the knockout device 50 is not limited to a device using the flow rate adjustment valve 55 which is a hydraulic servo valve, and may be a device whose operation is controlled by a servo motor, for example.

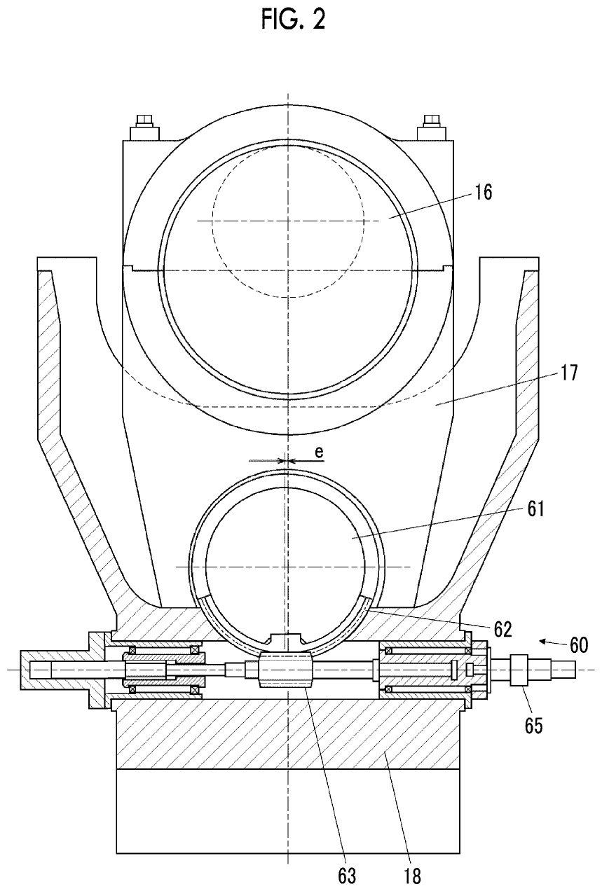

In addition, as illustrated in FIG. 2, the device main body 100 includes a shut height adjustment mechanism 60.

The shut height adjustment mechanism 60 adjusts a shut height. The shut height is a length (height) from a bottom dead center position of the slide 18 to an upper surface of the bed 23.

In the shut height adjustment mechanism 60, the eccentric wrist pin 61 penetrates the connecting rod 17 and the slide 18. In the eccentric wrist pin 61, a center of a connecting rod penetration portion and a center of a slide penetration portion are eccentric to each other by an eccentric amount e. A worm wheel 62 is mounted on the center of the slide penetration portion of the eccentric wrist pin 61. A worm shaft 63 meshes with the worm wheel 62, and the worm shaft 63 is rotated by a motor (servo motor) 65. Therefore, when the worm shaft 63 is driven and rotated by the servomotor 65, the eccentric wrist pin 61 rotates together with the worm wheel 62, and a position of the slide 18 is changed by a distance corresponding to a rotation angle thereof and the eccentric amount e. In this manner, the shut height can be adjusted.

FIG. 3 is a block diagram illustrating a schematic control configuration of the press device 1.

As illustrated in the drawing, the press device 1 includes the control device 70 that controls an operation of the device main body 100.

The control device 70 includes a display unit 71, an input unit 72, an alarm. unit 73, a storage unit 74, and a control unit 75.

The display unit 71 includes a display, and displays various types of information on the display, based on a display command from the control unit 75.

The input unit 72 includes various operation buttons, a keyboard, and a pointing device which receive a user' s operation, and an input signal corresponding to the received operation is transmitted to the control unit 75.

The alarm unit 73 outputs an alarm to notify a user of an abnormality of the device main body 100. An alarm mode thereof is not particularly limited. For example, the display unit 71 may output an alarm display, or a speaker (not illustrated) may output an alarm sound.

The storage unit 74 is a memory that stores a program or data for realizing various functions of the device main body 100 and functions as a work area. In the present embodiment, the storage unit 74 stores a shut height adjustment program 740 and load-thickness conversion data 741 in advance.

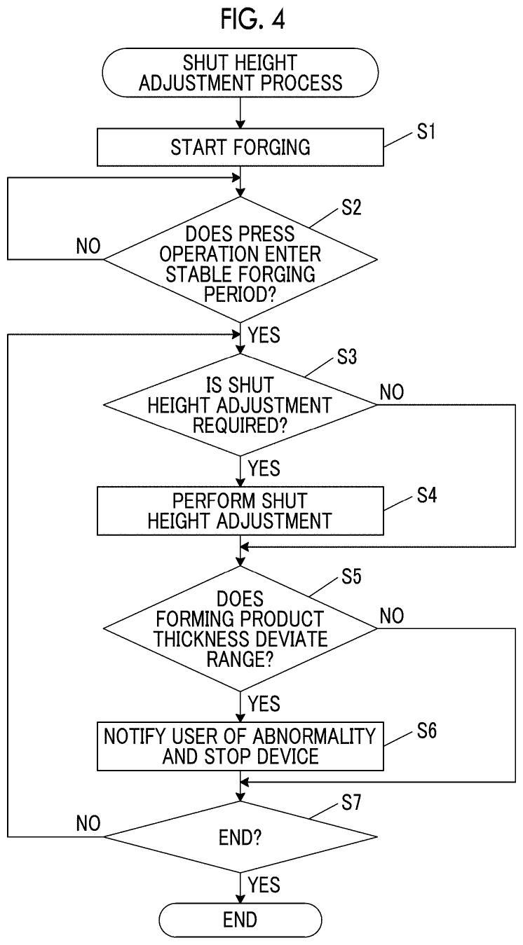

The shut height adjustment program 740 is a program for performing a shut height adjustment process (to be described later) (refer to FIG. 4).

The load-thickness conversion data 741 is a conversion formula for obtaining a forming product thickness H from the load F of the slide 18. The data can be obtained by measuring the thickness of the pressed forming product with a pass or a caliper in a test operation performed in advance, and obtaining a correlation with the load F at that time.

The control unit 75 centrally controls each unit of the press device 1. Specifically, the control unit 75 acquires a measurement value by using a thermometer 34 or a load meter 36, based on a user's operation or a predetermined program, or controls operations of the motor 11, the heater 33, the die changing device 35, the transport device 40, the lubrication device 41, the knockout device 50 (flow rate adjustment valve 55), and the shut height adjustment mechanism 60 (servo motor 65).

### Shut Height Adjustment Process

Subsequently, a shut height adjustment process for adjusting a shut height during hot forging will be described.

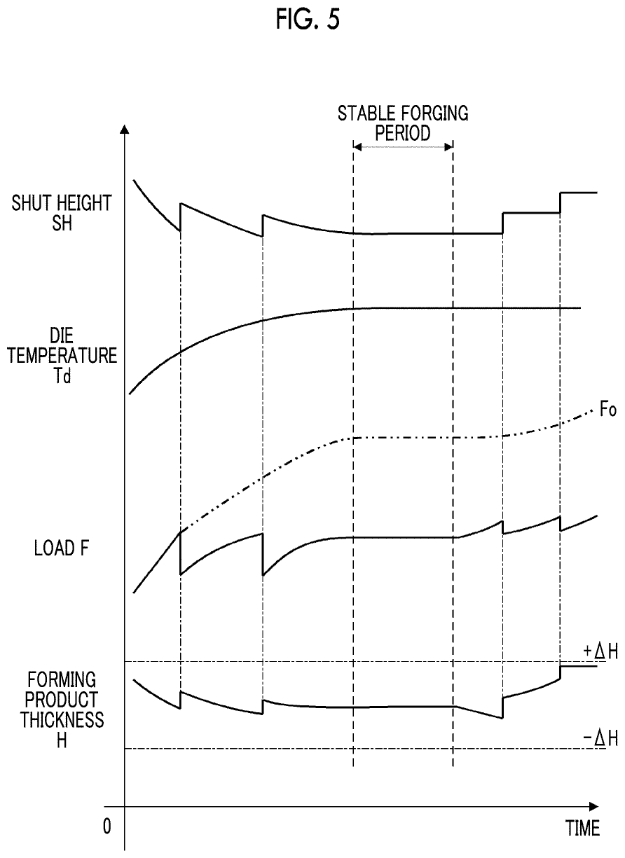

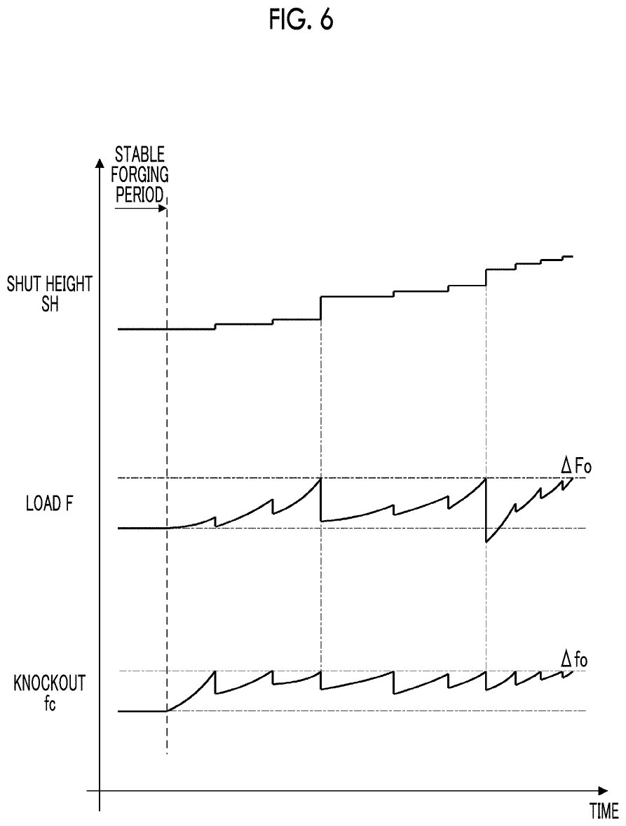

FIG. 4 is a flowchart illustrating a flow of the shut height adjustment process. FIG. 5 is a graph illustrating an example of time-dependent changes in a shut height SH, a die temperature Td, the load F, and a forming product thickness H, and FIG. 6 is a graph illustrating an example of time-dependent changes in the shut height SH, the load F, and a knockout force fc after a stable forging period. The reference numeral Fo indicated by a two-dot chain line in FIG. 5 is a change example in the load F when the shut height adjustment is not performed.

The shut height adjustment process is a process for adjusting the shut height during a press operation, and is particularly performed to suppress poor quality caused by residues of the die lubricant (to be described later). For example, the shut height adjustment process is performed when the operation of the press device 1 starts, and subsequently the control unit 75 reads and executes the shut height adjustment program 740 from the storage unit 74.

As illustrated in FIG. 4, when the shut height adjustment process is performed, the control unit 75 first starts the press operation of the press device 1 (Step S1).

Specifically, the control unit 75 operates the motor 11 of the drive unit 10 while heating the die to a predetermined temperature (for example, 150° C. or higher) by using the heater 33, and operates each unit such as the transport device 40 and the knockout device 50 to start hot forging of the workpiece (for example, aluminum). In addition, the control unit 75 starts measuring and recording a state quantity of each portion including the die temperature Td, the load F, and the forming product thickness H. The die temperature Td, the load F, and the forming product thickness H are measured by using the thermometer 34, the load meter 36, and the load-thickness conversion data 741.

In the present embodiment, the shut height is adjusted after the operation starts (before the stable forging period). The shut height adjustment herein is adjustment for suppressing a change in the shut height which is mainly caused by thermal expansion of the die, and is performed for a purpose different from that in Step S4 (to be described later). For example, the shut height adjustment is performed to suppress the load F, when the load F exceeds a predetermined threshold. The load F is substantially constant during the stable forging period. Accordingly, the shut height adjustment is not performed. The shut height adjustment may not be performed.

Next, the control unit 75 determines whether or not the press operation enters the stable forging period (Step S2), and when the control unit 75 determines that the press operation does not enter the stable forging period (Step S2; No), the process in Step S2 is repeated. As illustrated in FIG. 5, the “stable forging period” is a period during which the load F is substantially constant as the workpiece is distributed to have a substantially uniform thickness inside the die.

In Step S2, the control unit 75 detects the stable forging period, based on the load F acting on the slide 18 in the press direction. Specifically, the control unit 75 calculates a load change rate dF (=dF/dt), which is a time derivative value of the load F. When the load F and the load change rate dF fall within a range of a predetermined threshold (that is, α1<F<β1 and |dF|<γ1), the control unit 75 determines that the press operation enters the stable forging period. The threshold (α1, β1, or γ1) in this case is not particularly limited. In addition, in this case, it is preferable to use an average value of the loads F and the load change rates dF which are obtained multiple times (multiple shots).

The die temperature Td is stable in the stable forging period. Accordingly, the stable forging period may be detected by using the die temperature Td, instead of (or in combination with) the load F or the load change rate dF. In this case, when the die temperature Td or a temperature change rate dTd (=dTd/dt) which is a time derivative thereof falls within a range of a predetermined threshold (that is, α2<Td<β2 and |dTd|<γ2), the control unit 75 may determine that the press operation enters the stable forging period. The threshold (α2, β2, or γ2) in this case is not particularly limited.

Alternatively, instead of (or in combination with) the thresholds, the stable forging period may be detected by using an operation time and the number of press operations. In this case, the operation time for entering the stable forging period or the number of press operations (continuous operation time and the number of continuous press operations after the press operation starts) may be measured and set in advance by a test operation (or simulation) performed in advance.

Alternatively, in combination with the threshold, the stable forging period may be detected by using a distribution of the workpiece. In this case, for example, the distribution (disposition) of the workpiece inside the die is detected by using a photo sensor. When the workpiece is distributed inside the die in an area ratio of a prescribed level or higher, it may be determined that the press operation enters the stable forging period.

In Step S2, when the control unit 75 determines that the press operation enters the stable forging period (Step S2; Yes), the control unit 75 determines whether or not the shut height adjustment is required (Step S3). When the control unit 75 determines that the shut height adjustment is not required (Step S3; No) , the process proceeds to Step S5 (to be described later).

In Step S3, the control unit 75 determines whether or not the shut height adjustment is required, based on the load F and the load change rate dF. Specifically, the control unit 75 determines that shut height adjustment is required, when at least one of the load F and the load change rate dF deviates the range of the predetermined threshold (that is, F≤α1, F≥β1, or |dF|≥γ1). The threshold (α1, β1, or γ1) in this case is not particularly limited, and may be the same as or different from that when the control unit 75 determines that press operation enters the stable forging period in Step S2. In addition, in this case, it is preferable to use an average value of the loads F and the load change rates dF which are obtained multiple times (multiple shots).

A parameter (measurement value) used for determining whether or not the shut height adjustment is required is not limited to the load F or the load change rate dF.

For example, as illustrated in FIG. 6, a knockout force (pushing force) fc applied by the knockout pin 51 of the knockout device 50 may be used. The knockout force fc may be measured by measuring a pressure of the hydraulic cylinder 52. When the knockout device 50 is driven by a servo motor, a current value correlated with the knockout force fc may be measured. In this case, it is preferable to use an average value of the knockout forces fc obtained multiple times (multiple shots).

In addition, a holding torque of the servomotor 65 of the shut height adjustment mechanism 60 may be used. The holding torque may be detected and used, or a motor rotation position correlated with the torque may be detected by an encoder and used. In this case, it is preferable to use an average value of the holding torques (or the motor rotation positions) obtained multiple times (multiple shots).

Furthermore, the measurement values may be used in appropriate combination with each other.

When the control unit 75 determines in Step S3 that the shut height adjustment is required (Step S3; Yes), the control unit 75 performs the shut height adjustment (Step S4).

In the step, the control unit 75 controls an operation of the shut height adjustment mechanism 60, and adjusts the shut height SH to suppress fluctuations in the load F (or a parameter corresponding thereto) (for example, to set a value of the load F in the stable forging period). FIG. 6 illustrates an example in which the shut height adjustment is performed after being determined to be required when the load F exceeds a threshold upper limit ΔFo or when the knockout force fc exceeds a threshold upper limit Δfo.

In this way, the shut height adjustment is performed after the stable forging period. Accordingly, it is possible to suppress poor quality caused by a lubrication state between the die and the workpiece.

That is, in forging performed by heating the die to a predetermined temperature (for example, 150° C.) or higher, such as hot forging, the die lubricant is less likely to cleanly spread on the die surface (lubricating film is less likely to be uniformly formed) . Therefore, when the press operation is performed a prescribed number of times, residues (foreign matters) in which the die lubricant is solidified are generated inside the die. When the die is pressed in a state where the residue is unevenly distributed, the residues cause poor quality such as poor wall thickness and an insufficient thickness.

With regard to this phenomenon, the present inventors have found that the residues of the die lubricant start to be generated exclusively after the stable forging period. The control unit detects that the press operation enters the stable forging period. After the stable forging period, a force acting on the workpiece from the die to deform the workpiece is adjusted. In the present embodiment, the control unit detects that the press operation enters the stable forging period, and the height from the bottom dead center position of the slide to the upper surface of the bed, that is, the shut height is adjusted after the stable forging period. In this manner, it is possible to suppress the poor quality caused by generation of the residues of the die lubricant. In addition, the load F is changed (generally increases) when the residues progressively adhere to the die surface. Accordingly, the shut height adjustment is performed (whether or not the shut height adjustment is required is determined) , based on the load F. In this manner, it is possible to suitably suppress the poor quality.

In addition, the knockout force fc of the knockout device 50 is sensitively changed depending on a lubrication state between the die and the workpiece, and the holding torque of the servo motor 65 of the shut height adjustment mechanism 60 is sensitively changed in response to a change in the load F. Therefore, the shut height adjustment is performed by using the measurement values instead of (or in combination with) the load F. In this manner, the shut height adjustment can more accurately be performed.

In addition, in Step S4, when the shut height adjustment is performed, the lubrication device 41 may be controlled to adjust a spraying condition of the die lubricant (for example, to increase a spraying pressure, to decrease a lubricant concentration, or to lengthen a spraying time). In this manner, an improved lubrication state between the die and the workpiece may be achieved. The spraying condition may be adjusted together with the shut height adjustment, or may be adjusted before the shut height adjustment. Even when the lubrication state (generation state of the residues) of the die is not improved, the shut height adjustment may be performed.

Next, the control unit 75 determines whether or not the forming product thickness H deviates a predetermined range (Step S5). When the control unit 75 determines that the forming product thickness H does not deviate the predetermined range (Step S5; No) , the process proceeds to Step S7 (to be described later).

In Step S5, the control unit 75 determines whether or not the forming product thickness H deviates a range of an upper limit +ΔH and a lower limit −ΔH.

In addition, other parameters (for example, the load F and a shut height adjustment amount) correlated with the forming product thickness H may be used for the determination in Step S5.

When the control unit 75 determines in Step S5 that the forming product thickness H deviates the predetermined range (Step S5; Yes), the control unit 75 determines that an abnormality in the load F occurs (or there is a possibility that the abnormality may occur in the future). The control unit 75 operates the alarm unit 73 to notify a user of occurrence of the abnormality, and stops an operation of the device main body 100 (Step S6).

In this case, there is a possibility that a large amount of the residues of the die lubricant may be accumulated. Accordingly, it is preferable that the die is changed to a new die by the die changing device 35 after the device main body 100 is stopped.

Next, the control unit 75 determines whether or not to complete the shut height adjustment process (Step S7). When the control unit 75 determines not to complete the shut height adjustment process (Step S7; No), the process proceeds to Step S3 described above.

For example, when the control unit 75 determines to complete the shut height adjustment process due to the completed operation of the device main body 100 or the stop of the device in Step S6 (Step S7; Yes), the control unit 75 completes the shut height adjustment process.

### Technical Effects of Present Embodiment

As described above, according to the present embodiment, when it is determined that the press operation enters the stable forging period during which the load F of the slide 18 is stable, a force acting on the workpiece from the die to deform the workpiece is adjusted (shut height adjustment in the present embodiment), based on a predetermined measurement value.

In this manner, it is possible to suppress poor quality caused by the residues of the die lubricant which start to be generated after the stable forging period, and it is possible to improve productivity.

In addition, according to the present embodiment, it is determined whether or not the press operation enters the stable forging period, based on the load F and the load change rate dF. Therefore, the stable forging period can more accurately detected, compared to a case of using only the load F.

In addition, in addition to the load F and the load change rate dF, it is determined whether or not the press operation enters the stable forging period by using the die temperature Td. In this manner, the stable forging period can more accurately be detected.

In addition, according to the present embodiment, the force acting on the workpiece from the die to deform the workpiece is adjusted (shut height adjustment), based on at least one of the load F and the load change rate dF.

The load F is changed when the residues progressively adhere to the die surface. Accordingly, the shut height adjustment is performed (whether or not the shut height adjustment is required is determined) , based on the load F. In this manner, it is possible to suitably suppress the poor quality caused by the residues of the die lubricant.

In addition, according to the present embodiment, the shut height adjustment is performed, based on the holding torque of the servo motor 65 of the shut height adjustment mechanism 60.

The holding torque is sensitively changed in response to a change in the load F. Therefore, the shut height adjustment is performed by using the holding torque. In this manner, the shut height adjustment can more accurately be performed.

In addition, according to the present embodiment, the shut height adjustment is performed, based on the knockout force fc of the knockout device 50 that pushes the forming object out from the die.

The knockout force fc is sensitively changed depending on a lubrication state between the die and the workpiece. Therefore, the shut height adjustment is performed by using knockout force fc. In this manner, the shut height adjustment can more accurately be performed.

In addition, according to the present embodiment, when the forming product thickness H deviates from a predetermined range, an abnormality is notified, and an operation of the device main body 100 is stopped. Therefore, it is possible to avoid continuous use of the die to which a large amount of the residues may adhere.

Furthermore, after the operation of the device main body 100 is stopped, the die is changed to a new die by the die changing device 35. Therefore, productivity can be improved by automatically changing the die to which a large amount of the residues may adhere.

### Others

Hitherto, the embodiment of the present invention has been described. However, the present invention is not limited to the above-described embodiment.

For example, in the above-described embodiment, hot forging has been described as an example. However, without being limited to the hot forging, the embodiment of the present invention is widely applicable to forging performed by heating the die to a predetermined temperature at which the residues of the die lubricant may be generated.

Alternatively, details in the above-described embodiment can appropriately be changed within the scope not departing from the concept of the invention.

It should be understood that the invention is not limited to the above-described embodiment, but may be modified into various forms on the basis of the spirit of the invention. Additionally, the modifications are included in the scope of the invention.

What is claimed is:

1. A press device which causes a slide to advance and retreat to forge a forming object by using a die heated to a predetermined temperature, the press device comprising:
a determination unit that determines whether or not a press operation enters a stable forging period during which a mechanical load acting on the slide in a press direction is stable; and
a controller that adjusts a force acting on the forming object from the die to deform the forming object, based on a predetermined measurement value, when the determination unit determines that the press operation enters the stable forging period.

2. The press device according to claim 1,
wherein the determination unit determines whether or not the press operation enters the stable forging period, based on the load and a time-dependent change rate of the load.

3. The press device according to claim 1,
wherein the determination unit determines whether or not the press operation enters the stable forging period, based on a temperature measurement value correlated with a temperature of the die.

4. The press device according to claim 1,
wherein the determination unit determines whether or not the press operation enters the stable forging period, based on at least one of an operation time, the number of press operations, and a distribution of the forming object inside the die.

5. The press device according to claim 1,
wherein the controller uses at least one of the load and a time-dependent change rate of the load as the predetermined measurement value.

6. The press device according to claim 1, further comprising:
a shut height adjustment mechanism that adjusts a shut height,
wherein the controller causes the shut height adjustment mechanism to adjust the shut height to adjust a force acting between the die and the forming object.

7. The press device according to claim 6,
wherein the shut height adjustment mechanism includes an eccentric wrist pin that is eccentrically and rotatably mounted on an end portion of a connecting rod that causes the slide to advance and retreat, and a servo motor that rotates the eccentric wrist pin, and
the controller uses a holding torque of the servo motor as the predetermined measurement value.

8. The press device according to claim 6, further comprising:
a pushing device that pushes the forming object from the die,
wherein the controller uses a pushing force of the pushing device as the predetermined measurement value.

9. The press device according to claim 8,
wherein the pushing device is configured to include a pushing pin, a hydraulic cylinder, a hydraulic pump, and a flow rate adjustment valve.

10. The press device according to claim 9,
wherein the hydraulic cylinder includes a piston that advances and retreats in an upward-downward direction, and causes the push pin mounted on the piston to advance and retreat in the upward-downward direction,
the hydraulic pump is connected to a tank that stores oil and the hydraulic cylinder, and supplies the oil stored inside the tank to the hydraulic cylinder, and
the flow rate adjustment valve switches a connection state between the hydraulic cylinder and the hydraulic pump.

11. The press device according to claim 6, further comprising:
a thickness acquirer that acquires a thickness of a pressed forming object; and
a stopper that issues notification of an abnormality and stops an operation of a device main body, when the thickness of the forming object deviates a predetermined range.

12. The press device according to claim 11, further comprising:
a die changing device that changes the die,
wherein the stopper causes the die changing device to change the die with a new die after stopping the operation of the device main body.

13. The press device according to claim 1, further comprising:
a lubrication device that sprays a die lubricant on a surface of the die,
the lubrication device is configured to advance and retreat in a direction perpendicular to a press direction, and
the controller adjusts a spraying condition of the die lubricant.

14. The press device according to claim 13,
wherein the spraying condition is adjusted, based on at least one of a spraying pressure, a lubricant concentration, and a spraying time.

15. The press device according to claim 13,
wherein the spraying condition is adjusted before or together with shut height adjustment.

16. The press device according to claim 1, further comprising:
a transport device that transports the forming object.

17. A control method for a press device which causes a slide to advance and retreat to forge a forming object by using a die heated to a predetermined temperature, the control method comprising:
determining whether or not a press operation enters a stable forging period during which a mechanical load acting on the slide in a press direction is stable; and
adjusting a force acting on the forming object from the die to deform the forming object, based on a predetermined measurement value, when the determination process determines that the press operation enters the stable forging period.

18. A non-transitory computer readable medium storing a control program for a press device which causes a slide to advance and retreat to forge a forming object by using a die heated to a predetermined temperature, the control program causing a computer to execute a process comprising:
determining whether or not a press operation enters a stable forging period during which a mechanical load acting on the slide in a press direction is stable; and
adjusting a force acting on the forming object from the die to deform the forming object, based on a predetermined measurement value, when the determination unit determines that the press operation enters the stable forging period.
